(19) United States
(12) Patent Application Publication
(10) Pub. No.: US 2019/0308055 A1
(43) Pub. Date: Oct. 10, 2019

(54) LEAK-FREE EXERCISE DEVICES

(71) Applicant: Power Systems (PS), LLC, Chattanooga, TN (US)

(72) Inventor: Michael E. Bowers, Maryville, TN (US)

(21) Appl. No.: 16/374,431

(22) Filed: Apr. 3, 2019

Related U.S. Application Data
(60) Provisional application No. 62/652,729, filed on Apr. 4, 2018.
(60) Provisional application No. 62/800,262, filed on Feb. 1, 2019.

(51) Int. Cl. A63B 21/06

(52) U.S. Cl. CPC A63B 21/0603; B23K 13/00

(57) ABSTRACT

Embodiments of the present disclosure are directed to leak-free exercise devices that are soft and conformable due to being filled with granular material. The devices are formed from one or more flexible panels joined together to form a cavity and a filler material, such as sand, contained within the cavity. The devices comprise welded seams that prevent liquid or moisture from entering the cavity and/or granular material from exiting the cavity. In some embodiments, the one or more flexible panels may further be made of waterproof materials.

This application claims priority to U.S. Provisional Patent Application No. 62/652,729, filed on Apr. 4, 2018, and U.S. Provisional Patent Application No. 62/800,262, filed on Feb. 1, 2019, the entireties of which are incorporated by reference herein.

### BACKGROUND OF THE INVENTION

### Field of the Invention

This disclosure generally relates to exercise devices containing granular, pelleted or fibrous material that are leak free, more particularly to devices that avoid liquid or moisture leaking into the device and/or fill material leaking out of the device.

### Background

A variety of weighted devices are known in the art for exercising. Exercise types and weights used vary greatly depending on the activity and the user. In some instances, it is desirable to have a weighted device that is relatively soft and/or conformable so as to be able to be easily carried by a user, such as a sand bag, ball or log. In other instances, it is desirable to have a weighted device that is highly flexible such as a sand rope.

Various types of exercise devices containing granular, pelleted or fibrous fill material are currently available but have certain problems that make their use non-ideal. The inventors have presently recognized that problems with the existing technology include (1) leakage of granular, pelleted or fibrous fill materials, (2) not being waterproof, and (3) not easy to clean.

Currently available exercise devices containing granular, pelleted or fibrous fill material, due to not being waterproof, are limited to use in a dry environment to avoid the device becoming waterlogged. Additionally, such devices that are not waterproof can easily become adulterated when used in exercise environments. These environments often include moisture, such as sweat from the user and fluids that might be consumed by the user. Devices that are not resistant to water seepage will increase in weight and be more difficult to use. It has been found that the typical inlet for water is through the seams of the device, which are conventionally sewn seams. Thus it would be advantageous to have a device with all seams and openings that are impervious to liquid. Thus, the inventors have recognized that it would be desirable to have weighted, filled devices that are waterproof. In particular, it would be advantageous to have such a device with all seams being impervious to liquid.

In particular, one activity where this type of device is used is in obstacle course racing (OCR). These races involve running a course while also undertaking various physical challenges. A common obstacle performed in these races is a weighted carry, usually using some type of soft and conformable (e.g. sand bag, ball or log) weight. These types of races often take place outdoors and can involve wet and/or muddy conditions. Thus, the inventors have recognized that it would be particularly desirable to have sand bag, ball or log weights that are waterproof and thereby configured or specially adapted for use in obstacle course racing.

Other uses for exercise devices containing granular, pelleted or fibrous material (e.g. sand bag weights) include gym environments where such weights are used to build grip strength and coordination. Having a filled exercise device that is waterproof, prevents fill leakage, and is easy to clean (e.g., with common spray cleaners) is desirable in these settings as well.

Additionally, with current commercially available exercise devices containing granular, pelleted or fibrous materials, the fill materials can leak out of the device at the construction seams and/or the filling mechanism. In particular, the granular fill can leak out of stitched seams. For example, with use the sand breaks down and becomes dust which seeps through the stitching and sometimes even the fabric of the device. Over time, this leakage causes changes to the weight of the device, such that the stated weight of the device and its actual weight may not be the same. For this reason, gyms also do not like to use these products as it increases their maintenance needs and, if not handled properly, can be dangerous (loose sand or dust can cause slips). Thus, the inventors have recognized that it would be desirable to have exercise devices where the fill loss is minimized or eliminated.

Further, currently commercially available products are made of materials such as neoprene that are not easy to clean. The inventors have recognized that easy cleaning of the surface of the device is desired to remove both fluids from users (e.g. sweat) and also mud or dirt when used outdoors.

### SUMMARY OF THE DISCLOSURE

In one aspect, the disclosure provides a leak-free exercise device comprising: a body made from panels of waterproof material, where the panels are connected to form a leak-free cavity for containing a granular, pelleted or fibrous filler material. In a further aspect, the disclosure provides a leak-free exercise device comprising: a body made from panels of waterproof material, where the panels are connected to form a leak-free cavity for containing a granular, pelleted or fibrous filler material; and a sealable, leak-free closure for filling the device with the filler material, where, when sealed, the closure substantially prevents water from entering the device and filler material from exiting the device.

In another aspect, the leak free exercise device comprises panels that are connected by fabric welding. In some embodiments of the above aspects, the weld is a sonic weld.

In another aspect, the disclosure provides a leak-free exercise device comprising: a body made from panels of waterproof material, where the device is filled with granular filling materials and the panels are sonically welded to form the leak-free device, having no openings therein (i.e. completely sealed by sonic welding).

In an additional aspect, the disclosure provides a leak-free exercise device comprising: a body made from panels of waterproof material, where the device is filled with granular, pelleted or fibrous filler materials and the panels are sonically welded to form the leak-free device, having no openings therein, which is then optionally further reinforced at the welded seam. In some embodiments of the above aspects, the seam is reinforced utilizing an elastic closure, a hook and loop fastener, stitching, or lacing.

In a further aspect, the disclosure provides a leak-free exercise device with a sealable, leak-free closure comprising a waterproof zipper. In yet another aspect, the waterproof zipper is covered by a second closure. In some embodiments of the above aspects, the second closure is selected from the group consisting of an elastic closure, a hook and loop fastener, stitching, and lacing.

In another aspect, the waterproof material comprises polyvinyl chloride (PVC). In further aspects, the waterproof material also comprises rayon. In additional aspects the waterproof material comprises a double wall, and in even further aspects, the waterproof material comprises a multi-layered laminate material.

In an additional aspect, the disclosure provides a leak-free exercise device comprising: a body made from panels of waterproof material, where the panels may be connected to form a spherical, circular, tubular or cylindrical shape.

In a further additional aspect, the disclosure provides a leak-free exercise device comprising: a body made from panels of waterproof material, where the panels are connected to form a leak-free cavity for containing a granular filler material where the granular filler material is sand. In other embodiments, the granular filler material may be iron sand, rock, steel pellets, lead shot or zinc shot. In other embodiments, the filler material may be pelleted or fibrous filler. In some embodiments, the pelleted filler material is rubber pellets or lead pellets. In further embodiments, the device may contain more than one type of filler material.

Other aspects will be apparent to one of skill in the art upon review of the description and exemplary aspects and embodiments that follow.

### BRIEF DESCRIPTION OF THE DRAWINGS

The drawings are provided to help illustrate and describe certain features of the aspects and embodiments of the disclosure. However, the claims and disclosure are not limited to the precise arrangements and instrumentalities of the features depicted in the drawings.

FIG. 1 shows a diagram of an exemplary sand disk having a zipper closure, in a top-down view.

FIG. 2 illustrates an example of a multi-layer construction that may be used in creating the panels of the device.

FIG. 3 illustrates an example of a multi-layer construction, depicting four layers and the ring welds.

FIG. 4 shows an example PVC-Rayon material having PVC on one side and rayon on the other (backing).

FIG. 5 shows an example of a waterproof zipper.

FIG. 6 shows examples of outer texture that can be applied to the sand disk.

FIG. 7 shows an exemplary sand disk (unfilled) that is completely sealed by welding.

FIG. 8 is a close-up view of a welded seam having welting around the outer edge utilizing further stitching reinforcement.

FIG. 9 illustrates how outer layers of the fabric may be turned in on themselves, and then welded.

### DETAILED DESCRIPTION

Before continuing to describe various aspects and embodiments in further detail, it is to be understood that this disclosure is not limited to specific compositions or process steps and may vary. As used in this specification and the appended claims, the singular form “a”, “an” and “the” include plural referents unless the context clearly dictates otherwise.

Unless defined otherwise, all technical and scientific terms used herein have the same meaning as commonly understood by one of ordinary skill in the art to which this invention is related.

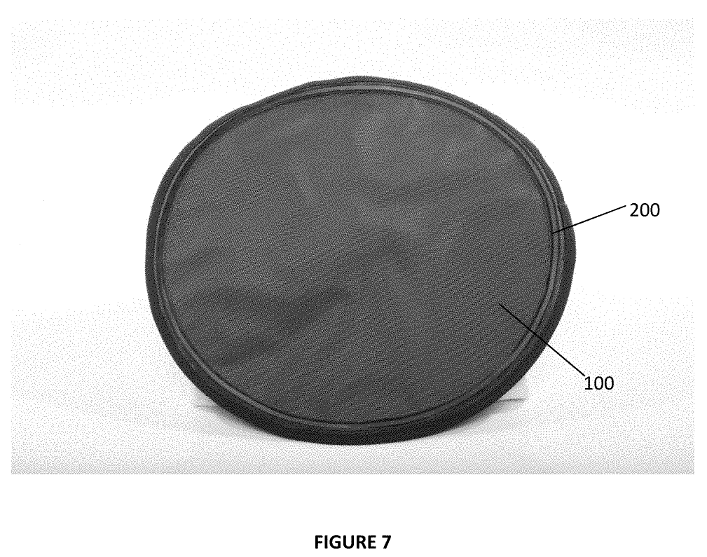

Embodiments of the present disclosure are directed to a leak-free exercise device having a body, which may be made from panels of waterproof material, in which the panels are connected and sealed to one another in a manner that forms a leak-free cavity for containing a granular filler material. The leak free cavity may be created using welding techniques to join the waterproof material. The device may be completely weld sealed after filling with granular filler with a strong, leak-free seal with no openings therein. For example, the embodiment shown in FIG. 7 contains a welded seam around the entire panel-intersection of the device.

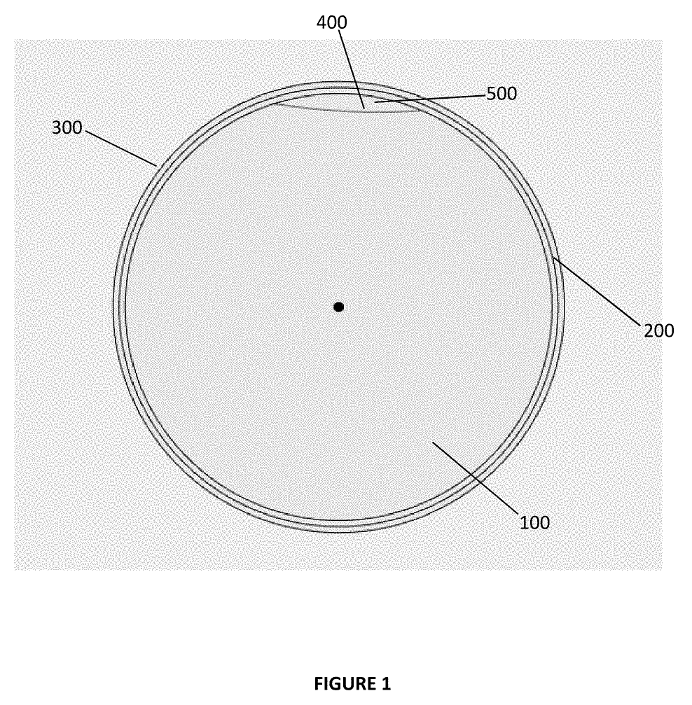

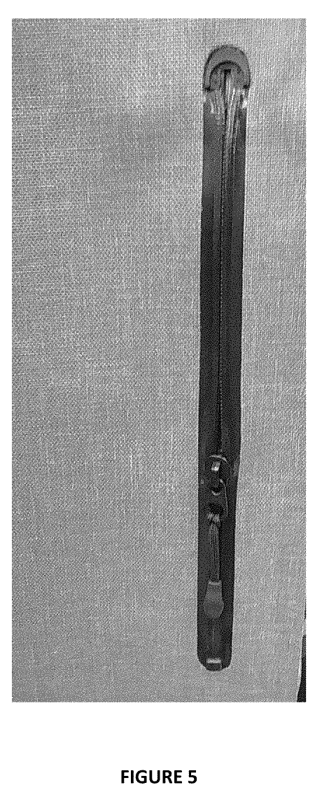

In other embodiments, a sealable, leak-free closure for filling the device with the granular filler material may be included. In addition to the welded seam, the sealable, leak-free closure may be configured to both prevent water from entering the device and prevent granular material from exiting the device. The embodiment shown in FIG. 1, for example, contains a water-proof zipper closure, such as that illustrated in FIG. 5.

Embodiments of the waterproof, leak-free exercise devices are easier to maintain when used in various exercise settings and do not become contaminated by fluids from the user (e.g. sweat) or the environment (e.g. mud, rain). They also do not leak granular material (e.g. sand) and thus are much cleaner when used in an indoor environment. The device itself may also be easily cleaned due to the waterproof materials from which it may be made, e.g. PVC.

Embodiments of the leak-free exercise devices are also less prone to failure at the seams of the device. Current methods for sealing exercise devices include stitching/sewing, which can result in failure at the stitching. Repeated use of an exercise device may cause the thread to pull through the fabric, resulting in a failure of a seam and leakage of the internal contents of the device. Failure at seams can become more acute with heavier weight devices and/or as the activity level used with a device is increased. Thus one advantage of using welded seams in an exercise device is the prevention of the seam failure.

FIG. 1 shows an exemplary device, illustrating the panels of flexible material 100 that are welded near the circumference, creating a welded seam 200. The welded seam can be further protected by a welted portion 300 that is welded and/or sewn. A welt refers to an added strip of fabric that is used to cover or bind an edge and can provide further reinforcement to a seam. FIG. 1 also depicts an example of a location for the leak-free closure 400 of the device (e.g. airtight and waterproof zipper) that is placed between layers of the multilayer construction. Additionally shown is a secondary closure 500. In this embodiment, the secondary closure 500 is a flap that closes over the primary, leak-free closure via hook and loop fastening.

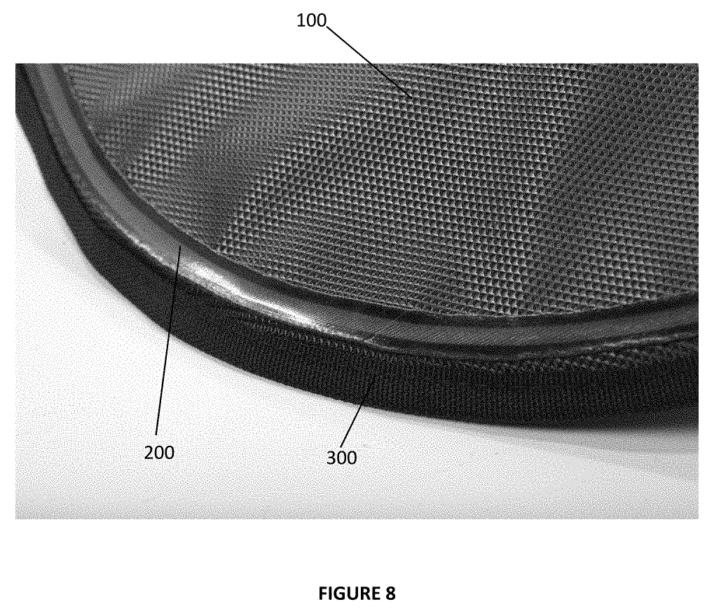

FIG. 7 shows an exemplary (unfilled) device that is completely sealed by welding. A top down view of a disk embodiment is shown, where panels 100 are connected by a welded seam 200. FIG. 8 is a zoomed in view of a portion of the sand disk shown in FIG. 7, showing the welded seam 200 and further showing welting around the periphery of the sand disk. Specifically, the periphery of the device is further protected by a welted portion 300 that is sewn. The welt 300 serves as a secondary reinforcement which may further enhance the strength of the seam 200 and/or prevent leakage if a primary seal were to fail.

Standard fabric connection techniques such as stitching are prone to leakage as the connection still has small openings therein. However, the presently disclosed fabric welding allows for strong, durable, leak-free seams because the fabric is completely fused. Fabric welding connects panels of fabric using heat and pressure, and may be performed through a variety of specific techniques.

The welding of panels to produce a leak-resistant exercise device may be performed using any of a number of welding techniques.

In some embodiments, for instance, the welding of the panels to produce a leak-resistant exercise device may be performed by dielectric welding. Dielectric welding utilizes a stationary base plate to hold the fabric, and a die. Energy is passed through the fabric, between the die and the base, thus melting the fabric and fusing it together. Types of dielectric welding include, but are not limited to radio frequency welding.

In other embodiments, the welding of the panels to produce a lead-resistant exercise device may be performed by rotary welding. In this technique, fabric is moved in a rotary fashion throughout the process. A welding area is heated and as the fabric passes through this area pressure is applied that causes the welding to take place. Types of rotary welding include, but are not limited to hot air, hot wedge, and ultrasonic/sonic welding. Rotary welding is usually a relatively fast process and is capable of making three dimensional finished products.

All plastic welding involves heat and pressure, but between the different types of plastic fabric welding, there are differences in the way heat is applied. The main difference is whether the method uses indirect or direct heat. In methods such as hot air or hot wedge, heat is applied directly to the external portions of the material. In methods such as ultrasonic welding and radio frequency welding, the heat is applied in an internal, indirect way. Indirect methods of heating include, but are not limited to friction, high-frequency electrical fields, electromagnetic fields, and ultrasonic vibration. In these methods heat is created at the welded interface in the material as a whole (not just at the surface). Heating occurs from the inside of the material.

Ultrasonic welding uses a tool or die to apply pressure between panels of material. The panels of material are then rubbed together by ultrasonic acoustic vibrations, creating friction and heat that fuses the two panels together. Ultrasonic welding may be used to weld any thermoplastic material, including panels made of different thermoplastic materials.

High frequency welding uses high frequency electromagnetic energy (e.g. radio waves) to generate heat in a material. In high frequency welding, the panels are held in a tool or die and radio waves are sent through the die and into the material. The radio waves cause the molecules in the panels to vibrate, causing heat and fusing the panels together to creates a solid-state weld (i.e., joint or seam). High frequency welding may be particularly desirable when the panels being joined are made from vinyl-based materials, e.g. PVC. Because high frequency welding produces heat at a molecular level, the resulting seam may be very strong.

Embodiments of this disclosure describe an exercise device having materials bonded by ultrasonic or high frequency welding of plastic-based fabric panels. Using high frequency or sonic welding to create the seams of the device results in a strong, leak free, waterproof interface. High frequency and sonic welding techniques are advantageous because high temperatures are not required. High frequency and sonic welding are also fast, easily automated and do not introduce contaminants to the materials being joined. Certain properties of seams produced by high frequency and ultrasonic welding make them highly suitable for exercise devices containing granular, pelleted or fibrous material. These properties include the formation of a continuous seam (with no small openings) and the ability of the seam to withstand wear without breakage of the seam. The strength of the weld is determined at least in part by the material used, time utilized for the welding, temperature of the welding process, and the like.

In addition to the type of weld that is applied, the strength of the resulting seam including the ability of the seam to withstand high-wear conditions, is also highly dependent on the width of the seam that is created by the weld. For exercise devices such as sand disks and medicine balls, it has presently been found that the welded seams should have a width of at least 3 mm, more desirably a width of at least 4 mm. More particularly, the welded seam should have a width between about 4 mm and about 30 mm, alternatively between about 4 mm and about 25 mm, alternatively between about 4 mm and about 20 mm. In some embodiments, the welded seam may have a width between about 5 mm and about 15 mm, alternatively between about 7 mm and about 13 mm, alternatively between about 8 mm and about 12 mm, and alternatively a width of about 10 mm.

It has also presently been found that the strength of a welded seam may decrease as the number of layers joined together increases above four. This may be problematic for the welding of panels to create medicine balls, because, conventionally, medicine balls comprise six layers of material joined together at one or more of the panel seams. Accordingly, embodiments of the present disclosure are also directed to medicine balls formed from a plurality of panels, in which no more than four panels of material are joined at any seam. For instance, all seams on the medicine ball may be welded according to the present disclosure and each weld joins no more than four panels together.

A secondary reinforcement such as a welt, secondary stitching, or a combination thereof, may further enhance the strength of the seam and/or prevent a situation in which rupture of the welded seam, i.e. the primary seal, leads to an immediate loss of the fill material. In some embodiments, a secondary reinforcement may comprise the addition of an additional layer as a welting to the seams. A welt is an additional section of fabric (e.g. a long, narrow strip) that is used to cover or bind an edge. In certain embodiments, secondary reinforcement entails adding welting to the circumference of a disc shaped device. In other embodiments, welting is added to some or all seams on various surfaces of a device in order to provide further reinforcement. In some embodiments, the welt material may be a plastic based fabric, including for example any of the materials described herein as being suitable for one or more panels of the device. Various additional methods of secondary reinforcement are also contemplated, including for example stitching. In some embodiments, for example, the panels may be stitched together around the circumference of a disc shaped exercise device, with the stitching being positioned closer to the periphery of the device than the welded seam so as to serve as a secondary seal. In some embodiments, the secondary reinforcement may comprise both a welt and stitching. For instance, the secondary reinforcement may be a PVC or nylon welting held in place with stitching, e.g. a double needle stitch. For instance, FIG. 8 illustrates an embodiment of a seam having a welted reinforcement stitched into place around the periphery of the exercise device.

In some embodiments, the one or more panels of the exercise device may be a polymeric fabric material made up of one or more layers. In some embodiments, for instance, the body of the device may comprise a thermoplastic material. Suitable materials for the exercise device include, but are not limited to, polyvinyl chloride (PVC), polyethylene (PE), polychloroprene (CR: neoprene; chloroprene rubber), polyethylene terephthalate (PET), polypropylene (PP), and polyurethane (PU). These materials may also impart the device with waterproof properties.

In some embodiments, one or more panels that form the body of the device may also comprise a backing material. The backing materials may comprise Rayon, Polyester, Aramid, Polyamide, PVA, Nylon, Nomex, glass, Kevlar, combinations thereof, or other polymer materials. The backing material can impart extra strength and flexibility to the device. The backing material may also be used to provide an enhanced welded seal.

In some embodiments, the body of the device may have multiple layers. In some embodiments, for example, the body of the device may have a double wall. For instance, the exercise device may comprise an outer, or exterior, layer made of PVC and an inner backing layer, or interior layer, made of rayon. Additional intermediate layers may also be included.

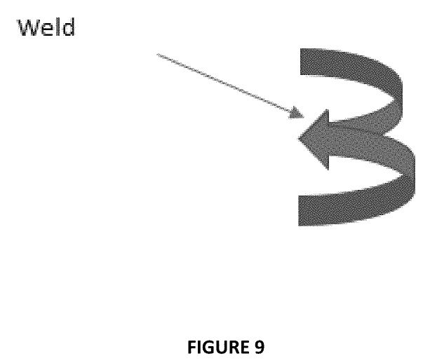

The material of the interior layer may be selected to provide an improved welded seal. For instance, the interior layers may be brought into contact and more effectively welded to one another than the exterior layers. In other embodiments, single layers of material may be directly welded to each other; or outer layers of the fabric may be turned in on themselves, and then welded as shown, for example, in FIG. 9.

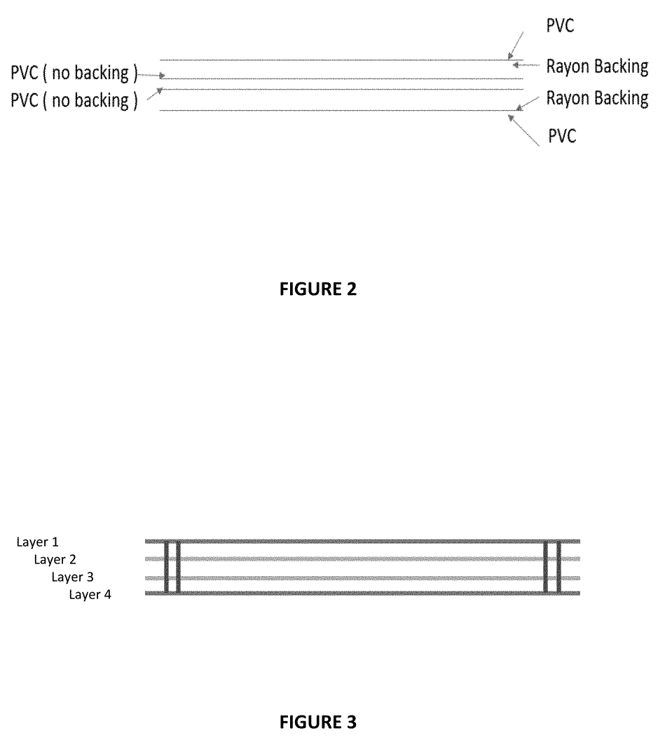

One exemplary multilayer construction is shown in FIGS. 2 and 3, involves four layers. As shown in the illustrated example, the outermost layers, i.e. layers one and four, can be expanded PVC (e.g. 100% expanded PVC) and the interior layers, i.e. two and three, can be PVC. As illustrated, the outermost layers can optionally have rayon backing for flexibility and strength. Since rayon does not bond well to itself, however, a better seal can be formed when additional sheet(s) of material—in this example, layers two and three—are sandwiched between the rayon-backed layers. In the illustrated example, the two outer layers are PVC with a rayon backing and the two inner layers are PVC that will effectively bond to both the rayon backing of layers one and four and to each other. All the layers may be welded together in one or more ring welds, as shown in FIG. 3, utilizing fabric welding techniques such as those described in more detail below.

Specifically, in the embodiment shown in FIGS. 2 and 3, layer 1 is a 100% expanded PVC with a non-slip surface (e.g. diamond embossed pattern) applied on its exterior surface and a rayon backing. Layers 2 and 3 are PVC only. Layer 4 is a 100% expanded PVC with or without a non-slip surface (e.g. diamond embossed pattern) applied on its exterior surface and a rayon backing and can be identical to layer 1. PVC layers 2 and 3 are to allow the rayon backed material to be welded together. The rayon adds strength to the fabric and to the weld.

In some multi-layer embodiments, welding of the layers to each other can result in concentric bladders (i.e. cavities). For example, in the embodiment shown in FIGS. 2 and 3, welded layers 1+2 can form an inner cavity and layers 3+4 can form an outer cavity, with the inner and outer cavities being concentric (one inside the other). This configuration can add strength and leak resistance to the device. One may place filler material in only the inner cavity, thus further protecting the overall device from leaks.

In other embodiments, a single layer of PVC may be placed between two layers of PVC having rayon backings to create a three-layer construction. As in the above-described embodiment, the middle layer of PVC may add to the strength of the weld and thus the overall durability of the construction.

The multi-layer construction allows for extremely strong fabric welds, imparting the device with leak-free properties even where the exercise devices are used under heavy-wear conditions. Specifically, the sandwiched layer(s) of PVC between the PVC/rayon layers as described above provides an advantageously strong seam, particularly when welded using the high frequency welding techniques described herein.

In other embodiments, an advantageously strong seam may be created by turning or folding the fabric in on itself and welding the thus created edge. FIG. 9 depicts the direction of folding the fabric and the location of the weld.

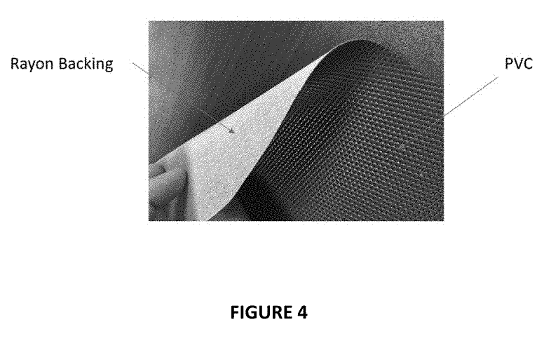

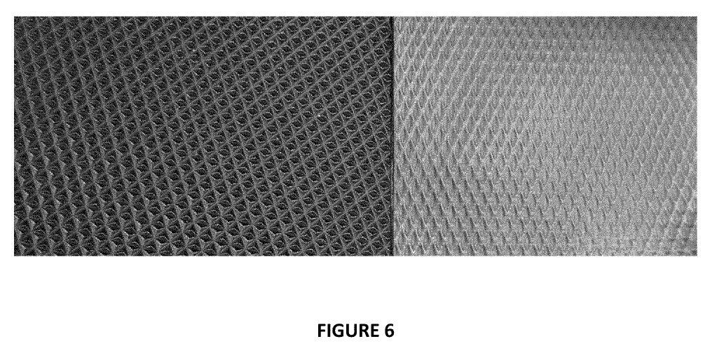

In some embodiments, one or more surfaces of the exercise device may comprise a non-slip surface. One example of a non-slip surface is an embossed texture or pattern, e.g. diamond embossed pattern, which is shown in FIGS. 4 and 6.

In some embodiments, the entire connection between panels is sealed by a welded seam. For instance, in a sand disk, a welded seam may be provided to join two panels together about the entire circumference of the device. In other embodiments, the device may include a leak-proof filling mechanism. That is, it may have a way to open the device to put granular, pelleted or fibrous material inside, and a closing mechanism to seal the opening once the desired amount of fill material is inserted. The closing mechanism is desirably leak-proof and waterproof.

In embodiments that are completely sealed, the device is welded around the intersection of at least two fabric panels after the device is filled with the granular filler material. For instance, in one embodiment, inner PVC layers may be welded to make a pouch with a small opening that is then used to fill the device with granular fill. This pouch is then sealed by welding to prevent any loss of fill material. In some embodiments, a secondary layer can then be added to the device. For instance, an outer layer of material (e.g., PVC) may be added and the entire outer perimeter may be welded with the filler inside.

Some embodiments include a zipper closure, desirably an airtight and waterproof zipper. Such zippers can be made from, e.g., polyester, polyvinyl chloride (PVC), polyethylene (PE), polychloroprene (CR: neoprene; chloroprene rubber), polypropylene (PP), or Polyurethane (PU). The zipper may comprise two polyester fabric tapes. The ends may be sealed by chloroprene rubber, such as may be formed by vulcanization molding. Part of the fabric tape may be made by coating the polyester fabric with chloroprene rubber. The inner teeth may be fixed on the outer teeth through the fabric tape. When the zipper slider closes up the two fabric tapes, the fabric tape with elasticity between the outer teeth will be compressed into shape and a double seal will be formed. An exemplary zipper welded in a fabric is shown in FIG. 5. Such a zipper can effectively provide protection against water, dust, etc. when it is completely closed. Even when exposed to pressure and bending, the zipper can still keep the abovementioned sealing properties.

The placement of the waterproof zipper may also assist in maintaining the leak-free status of the device. For instance, in some embodiments, the zipper may be welded between inner layers of a multilayer construction as shown in FIG. 1. This allows access to the inner portion of the device for filling. In some embodiments, this inner portion is a bladder formed by the welding of multiple layers (see, e.g. the layer configurations of FIGS. 2 and 3). In some embodiments, the waterproof zipper may be concealed by a secondary closure which prevents the zipper from accidentally being jarred open and assists in maintaining the leak free status of the device.

A secondary closure can comprise a standard closure such as an elastic closure, a hook and loop fastener, lacing, or a combination thereof. In some embodiments, the second closure may be a hook and loop fastener, which is sewn to the lips of the opening for the zipper. Since the second closure is outside the inner bladder it does not impact the waterproof design of the sealable, leak-free closure. In other embodiments, the secondary closure may be a flap that closes over the waterproof zipper. In some embodiments, this flap closes via hook and loop fastening.

In some embodiments, the sealable, leak-free primary closure may be contiguous with the welded seam of the device. The size of the closure may vary with the size of the disk. In some embodiments, the sonic welded seam may comprise 95% of the edge, while the other 5% is the sealable closure. In other embodiments, the seam may comprise 90%, 85%, 80% or 75% of the edge, with the sealable closure comprising the remaining 10%, 15%, 20% or 25% of the circumference. In some embodiments, for example, the opening/closure may be between about 3 and about 8 inches long.

The exercise devices described herein contain a granular filler material. In some embodiments, the granular filler material may be sand. Other granular materials that may be used include iron sand, rock, steel pellets, lead shot or zinc shot, and combinations thereof. In other embodiments, pelleted or fibrous filler materials may be used. Pelleted filler includes, but is not limited to, rubber pellets or lead pellets, or combinations thereof. The device may contain more than one type of filler material depending on the weight needed and use of the device.

Embodiments of the exercise device can have a variety of shapes. In some embodiments, the exercise device may have a circular or cylindrical shape, also called a disk. When in a disk shape, the exercise device may generally be referred to as a sand disk. These may be round or elliptical, and can have a “pancake”-type cross section. In some embodiments, the exercise device may be spherical (e.g. ball), similar to currently existing wall balls or medicine balls. In some embodiments, the exercise device may be tubular (e.g. rope), similar to existing exercise weighted ropes. In some embodiments, the exercise device may be cylindrical (e.g. log), similar to existing cylindrical weights. Other shapes are also contemplated.

Embodiments of the exercise device can also have additional handles, straps or connectors attached thereto, in addition to the welded seams that contain the granular filler. The additional handles, straps or connectors can assist the user in performing exercises by allowing the device to be carried, thrown or manipulated in various ways. Straps on the device may allow for connections to a stabilizer (e.g. attachments to a wall in the case of a rope shaped device.)

The size of the device may vary based on the desired weight and dimensions. However, in some embodiments, the size of the device may remain constant, and varying weights may be achieved by varying the composition of the filler material. Devices between 1 lb and 150 lb are contemplated. Also contemplated is a set of exercise devices, each varying in weight in pre-determined increments. Those increments may vary between 1 lb and 150 lb. For example, a set of devices may comprise a 10 lb device, a 20 lb device, a 30 lb device, and a 40 lb device.

While specific aspects of the subject disclosure have been discussed, the above specification is illustrative and not restrictive. Many variations of the disclosure will become apparent to those skilled in the art upon review of this specification and the claims below. The full scope of the disclosure should be determined by reference to the claims, along with their full scope of equivalents, and the specification, along with such variations.

The invention claimed is:

1. A leak-free exercise device comprising:
a body made from one or more flexible panels, wherein said one or more flexible panels are joined by a welded seam to form a cavity; and
a filler within the cavity, the filler comprising a granular material, a pelleted material, a fibrous material, or a combination thereof;
wherein the welded seam prevents (i) water from entering the device and (ii) the filler from exiting the device.

2. The device of claim 1, wherein the device further comprises a sealable, leak-free closure for adding the filler to the cavity.

3. The device of claim 1, wherein the panels are connected by a high-frequency weld.

4. The device of claim 1, wherein the panels are connected by an ultrasonic weld.

5. The device of claim 1, wherein the welded seam further comprises a secondary seal.

6. The device of claim 5, wherein the secondary seal comprises a hook and loop fastener, stitching, welting, or lacing.

7. The device of claim 2, wherein said sealable, leak-free closure comprises a waterproof zipper.

8. The device of claim 7, wherein said waterproof zipper is covered by a second closure.

9. The device of claim 8, wherein said second closure is selected from the group consisting of an elastic closure, a hook and loop fastener, and lacing.

10. The device of claim 1, wherein at least one of the one or more flexible panels comprises polyvinyl chloride (PVC).

11. The device of claim 10, wherein at least one of the one or more flexible panels further comprises a rayon backing layer.

12. The device of claim 1, wherein at least one of the one or more panels comprises a multi-layered material.

13. The device of claim 1, wherein the filler is sand.

14. The device of claim 1, wherein the one or more flexible panels are made from a waterproof material.

15. The device of claim 1, wherein the welded seam has a width of at least 4 mm.

16. The device of claim 1, wherein the welded seam has a width between about 5 mm and about 20 mm.

17. The device of claim 16, wherein the welded seam has a width between about 7 mm and about 15 mm.

18. The device of claim 1, wherein the body comprises a non-slip surface.

19. The device of claim 1, wherein the exercise device is a disk or ball.

20. The device of claim 1, wherein the exercise device is an exercise rope.
